(19) United States
(12) Patent Application Publication
(10) Pub. No.: US 2017/0004554 A1
(43) Pub. Date: Jan. 5, 2017

(54) SYSTEM AND METHOD FOR PORTABLE SHOPPING PLATFORM UTILIZING AN IMAGE SEARCH OR VOICE COMMAND

(71) Applicant: Eye-Buy LLC, Fulton, MD (US)

(72) Inventor: Clayborne Chavers, SR., Fulton, MD (US)

(73) Assignee: Eye-Buy LLC, Fulton, MD (US)

(21) Appl. No.: 15/202,535

(22) Filed: Jul. 5, 2016

Related U.S. Application Data
(63) Continuation of application No. 62/187,944, filed on Jul. 2, 2015.

(51) Int. Cl. G06Q 30/06; G06F 17/30

(52) U.S. Cl. CPC G06Q 30/0623; G06F 17/30867; G06F 17/30268

(57) ABSTRACT

The present invention includes a method for searching for products based on indirect product descriptions, such as images and voice recitations. The invention searches utilizing user-created parameters and returns products meeting the parameters to the user. User-defined product descriptions may be added to the database to aid in future searches by other users.

### RELATED APPLICATIONS

This application is a continuation, and claims Priority Under 35 U.S.C. §120 From, U.S. Provisional Patent Application 62/187,944 Titled SYSTEM AND METHOD FOR PORTABLE SHOPPING PLATFORM UTILIZING AN IMAGE SEARCH OR VOICE COMMAND filed on Jul. 2, 2015, the specification of which is hereby incorporated by reference.

### FIELD OF THE INVENTION

The present invention relates to the field data analysis and more specifically to the field of product and service analysis.

### SUMMARY

Described herein is a mobile shopping system and method for performing a search for an item and/or product and/or services available in an e-commerce inventory comprised of inventory compiled by acquisition through the scanned data of the retailer and manufacture or through links to e-commerce websites for the products and/or services, wherein the search is based on a voice command or an image of the item, and wherein the search is conducted for an item of inventory against a pre-populated database or an iteratively performed search of a plurality of third-party websites, until a match for one or more of the item of inventory is found. The system is further configured with means of offering the item of inventory for sale, and completing a sales transaction. The system may be further configured with providing tracking information regarding the sales transaction.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of a system of the present invention.

FIG. 2 is a view of an exemplary implementation of the method of the present invention.

FIG. 3 is a view of an exemplary registration step according to one embodiment of the present invention.

FIG. 4 is a view of an exemplary checkout step according to one embodiment of the present invention.

FIG. 5 is a view of shows an exemplary search according to one embodiment of the present invention.

FIG. 6 is a view of an ecosystem of the present invention.

FIG. 7 is a view of an ecosystem of the present invention

### DETAILED DESCRIPTION

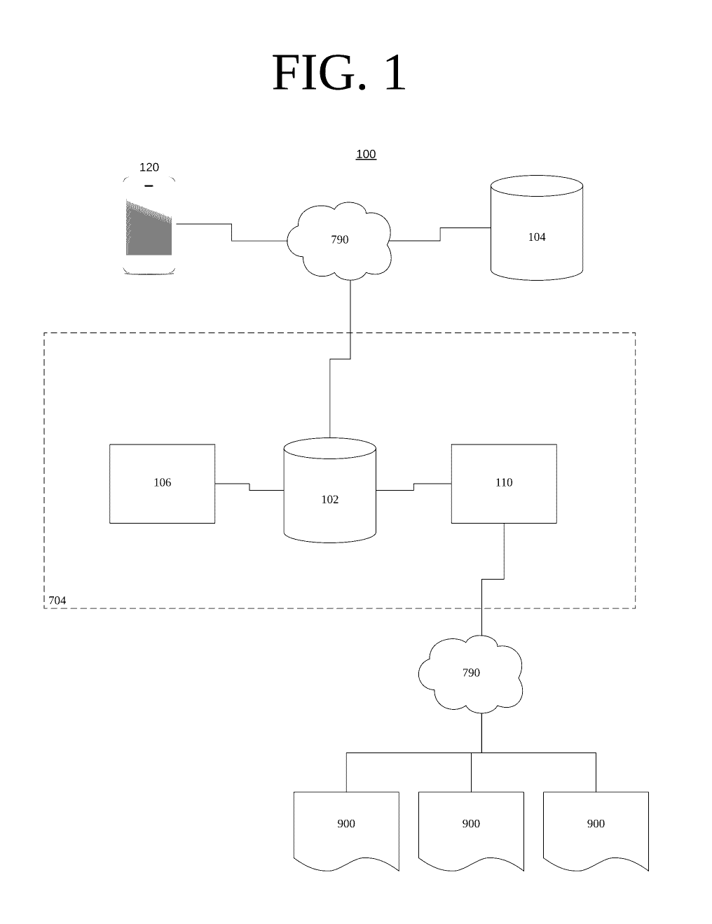

Turning now to FIG. 1, the system 100 comprises a portable electronic device or other computing device 120 (“Device”). Modern computing devices are configured with data input means (e.g., keyboards physical and virtual), image capture means (e.g., cameras), voice capture means (e.g., microphones), arithmetic logic unit and nontransitory storage media.

The present invention 100 includes a system engine 102 that includes the database, processor, and other modules for the operation of the system 100 and process of the present invention. The system database 102 may be stored on a system nontransitory storage medium 704. The system database is in signaled communication with a purchase gateway 106 and Wide Area Network (“WAN”) crawler 110. A user may use a computer device 120 to access the system backend database 102 over a WAN, including the Internet, to search for desired products. A desired product of the present invention is a product about which a user desires, but about which s/he can only supply limited information, e.g. a description or photograph. The system 100 in turn utilizes databases 104 of commercial entities to search for the desired product among target products until a target product is verified to be the same, or an acceptable substitute for the desired product. For purposes of the present disclosure, a target product is a product that is a candidate in a search for the desired product—or an acceptable substitute thereof.

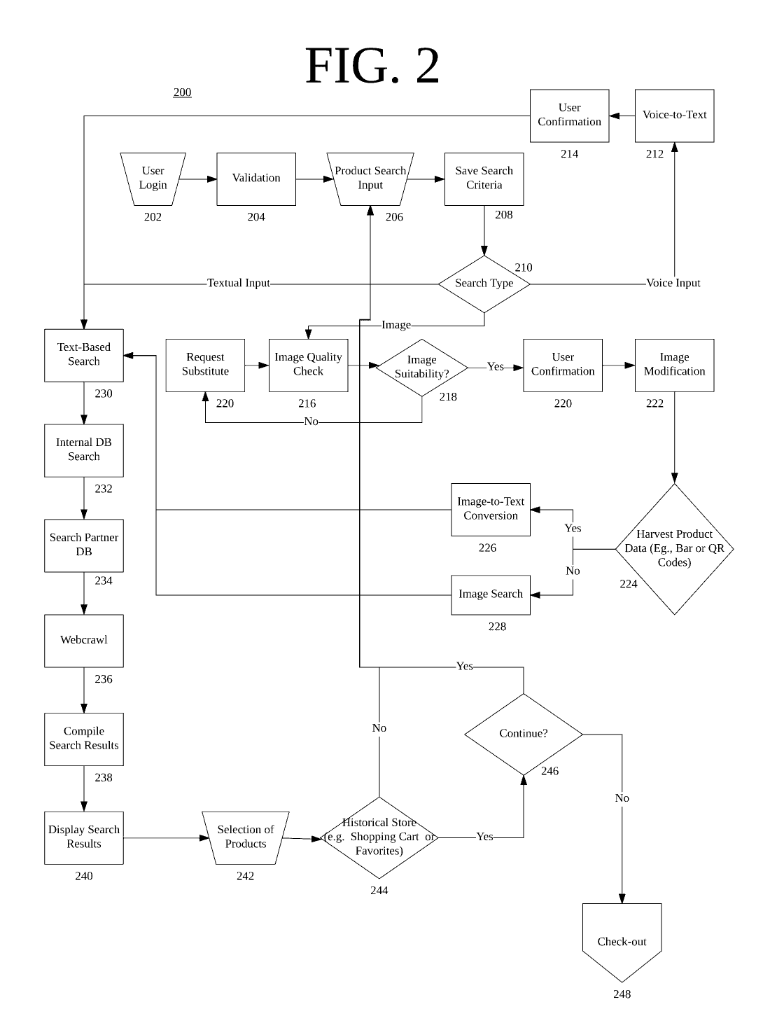

Turning now to FIG. 2, the method 200 present invention utilizes computing devices to access one or more commercial product inventory databases, wherein products searched with one or more searchable parameters. A user provides 202 credentials to access a user account. The user may then be validated 204. A user may then provide search inputs 206 that include direct or indirect search elements as well as search parameters. A direct search element includes elements that require no further conversion, such as direct textual entries. An indirect search element includes evidence of a product for which translation is required to search in a textual fashion. Exemplary indirect search elements include images and voice recitations.

The method comprises the steps of receiving 206 one or both of an image of the product or a voice command describing the product; converting 212 the image into one or more image search attributes and/or converting 226 the voice command into one or more keyword search attributes. The search parameters may be saved 208. The method discerns 210 the type the search applicable and proceeds with the applicable step(s). For voice recitations, the method is configured with an audio, or voice, command input, such as a voice interface. An audio-based search comprises capturing a voice command via the voice interface, converting all or a portion of an audio command into text or other alphanumeric characters by comparing one or more sounds or words to a recognition library. In another embodiment, the audio-based search is configured for video-based search utilizing audio from the video selected as the basis for an item of inventory search. The voice input as a raw file, or as translated information may be confirmed/edited 214 by the user.

In another embodiment, the method is configured to perform an image-based search, wherein the method receives a search image comprised of a digital image, and performs an image analysis to harvest 224 identifying attributes. The harvester 224 of the present invention may harvest data directly 226, such as the information appearing in the image (e.g., QR codes, bar codes, product names and descriptions, etc.) or harvest data indirectly 228, such as color sampling to determine hues, product outlining to discern product types (e.g., cars from trucks, etc.), etc. The method may further perform image quality analyses, including an image quality check 216 measuring resolution or other image characteristics. If the image includes undesirable attributes, a check 218 may request 220 a substitute image. The user may confirm 220 the suitability of the uploaded image. From there, the image may be modified 222 by the method, for example to crop or excise portions unrelated to the search. In a preferred embodiment, the attributes associated with identifying parameters are retained 244 by a history indexer for later use in new searches by the same user or a distinct user, and also for short-term applicability related to immediate purchase decisions by the present user. The method utilizes the parameters to search textually 230 a pre-populated database of images wherein each image is indexed with one or more identifiers for matching against the image-identifying parameters from the search image. A single image may have multiple identifiers, for example, an image of a car may have identifiers related to make, model, color, year, geographic data, and the like. In one embodiment, the identifies are stored as attributes associated with the image.

In one embodiment, an image search comprises selecting a search image, wherein the image may be captured via a camera on a portable device or selected from a library of images stored locally on the device or in a database remote from the device. In another embodiment, the system is configured with an image processing engine that processes images. Search images may be manipulated, rotated, resized, or adjusted for color, among other processing features. Search images are compared against database images utilizing one or more of metadata, or pixel-wise comparison of images. In another embodiment, the system is configured for template matching, and 2D and 3D comparisons. In yet another embodiment, the system is configured for video-based image search for a desired product.

The search 230 includes the textual attributes translated from the voice recitation or image conversation, as well as any other desirable search elements. For example, the search 230 may include not only a textual description of an image but also a comparison of an image of a desired product to images of target products. The method communicates with the one or more commercial inventory databases 234, either as a direct feed or as WAN crawling 236, as well as internal databases 232. In order to determine if a desired product has product textual attributes that match a target product attributes, the method, collects 238 the product information for one or more matches, including points of purchase information, and displays 240 the compiled product information from the database to the computing device of the user. Because the present invention utilizes ‘backwards’ product searching, the search may not be finished in a single session; but rather the search may be ongoing over a span of days, weeks, months, etc. wherein the method periodically checks-in with the user. The compiled list of target products include those that have been “verified” to be comparable to the attributes submitted as part of the desired product.

The user may then select 242 such verified target products as the user wishes to purchase, which may then be indexed 242 into the history of the user for purchase. The user may desire to begin the process with differing input or continue 246 to product purchase 248.

Exemplary Mobile Shopping Platform

In one exemplary embodiment, the system comprises a mobile shopping platform configured with various features described herein, including but not limited to features to permit shopping from search to delivery of product, and including delivery tracking. In another embodiment, the system is configured as a social network, permitting a user to create an account and share information from the account, at the user's discretion, to one or more additional users by connecting over the social network. Also provided is a sharing platform, which allows a user to share content and associated data with others amongst and within a network of other users. In another embodiment, the system is configured for users to share their content, including but not limited to: search results, search terms, items of interest to users, and the like. The system is also configured with one or more tools/features, which permit users to comment, or interact directly, such as messaging features, with other users regarding items and content they have shared on the network. For example, a user may be searching for, or may have purchased, a particular item, and post a picture of the item; other users on the platform may post comments regarding the item, which may then be visible in a user feed or user inbox.

In one embodiment, an ongoing iterative search is performed based what user selects as the search terms, although additional configurations are envisioned. For example: the user may select a specific length of time to perform the search; the user may select a minimum or maximum match for search parameter; and the user may store searches and/or search terms and/or search parameters for future reference. The configured device maintains the step of performing a continuous and iterative search amongst databases and amongst business partners, such as third-party websites or other inventory databases. In another embodiment, the configured device presents search results with seller information, where the product is available, nearest location, best price and the deals. The search results may be presented in various formats, and with varying detail regarding the item of inventory. In yet another embodiment, the configured device provides alerts and notifications, such as alerts for deals, price drops, new products and sales/clearance, and notification about product delivery status and other related messages.

In one embodiment, the system includes means of storing coupons and discounts, and applies the coupons and/or discounts at time of check out.

In another embodiment, the system includes a two-click buying mode for the portable electronic device. In one embodiment, the two step process comprises confirming an order; and selecting a payment method. In one embodiment, a payment is processed through a payment gateway based on the payment method selected.

In another embodiment the system is configured with a search engine, wherein the search engine utilizes user search history. In one embodiment, the search engine is iterative and continues performing a search on a server continuously executing search scripts. Input for the search engine comes from multiple sources, namely Text-base, Voice, Image, Video, Bar code, QR Code, SKU or Product Code, and is configured to use the intelligence build over the user choices over time. In another embodiment, the search is customized, to select search parameters—for example, the system is configured with filters so that a user may customize, narrow or expand a search, search terms, or search results depending on selections made by the user. The search will take into account any filters, restrictions or expansions selected by the user.

For example: based on history, a user searches for Nikon camera products. If the user is searching for camera products, the search is limited to Nikon unless user changes the search criteria to include other brands, such as Canon or Sony or Fuji or Pentax. The search engine keeps searching and presents the search results when the right criteria is matched; for example, a product is found at the requested price and location.

Data Sources for Search

The system comprises a pre-populated database 102 comprised of inventory data from one of various sources, including but not limited to: product and deals information searched and selectively saved by a user; deal patterns saved in database to locate the right retailer for the right product; selective saving data from WebCrawlers based on search patterns; data shared by members in a social network; data obtained using WebCrawlers searching WAN resources 900; and data provided by manufacturers, retailers and other trading partners. The items available in the commerce inventory include, but are not limited to: articles of manufacture, goods and services, promotions, coupon-codes, special offerings, limited edition offerings, hospitality offers (restaurants, etc).

Payment Processing

The system is configured with a payment gateway 106, and web-based services will be integrated into a payment processing engine. For example: when a user selects a payment option, the control is passed on to the payment gateway. When the transaction has been completed and a payment processed, a payment gateway will return a confirmation, which will be saved in the order payment details.

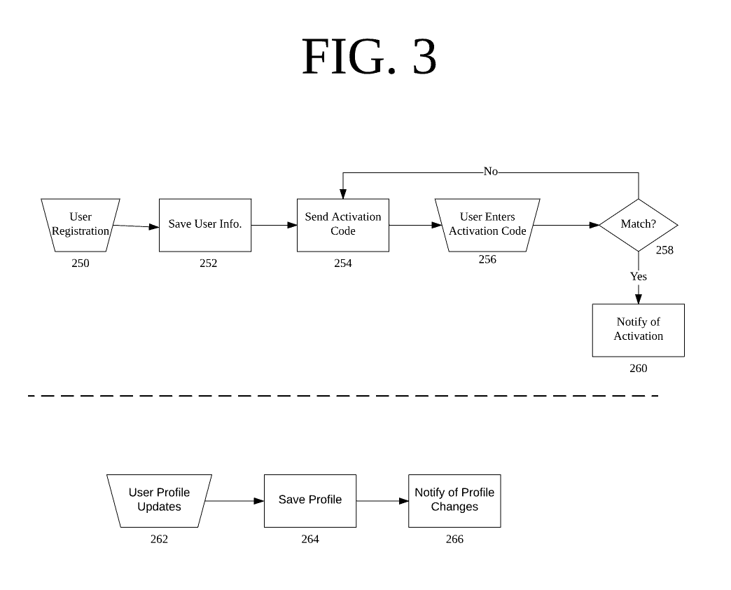

Turning now to FIG. 3, the present invention includes a method by which a user registers to validate its credentials. The user registers 250 and provides such information as may be related to its enjoyment of the invention. The user information is saved 252. A user may be sent 254 an activation code that may be later entered 256 to verify the user. If a match 258, the user is notified 260 of access allowed on the system. The user may update 262 its profile as needed, and save 264 the updated information. The user would be notified 266 of any information updates.

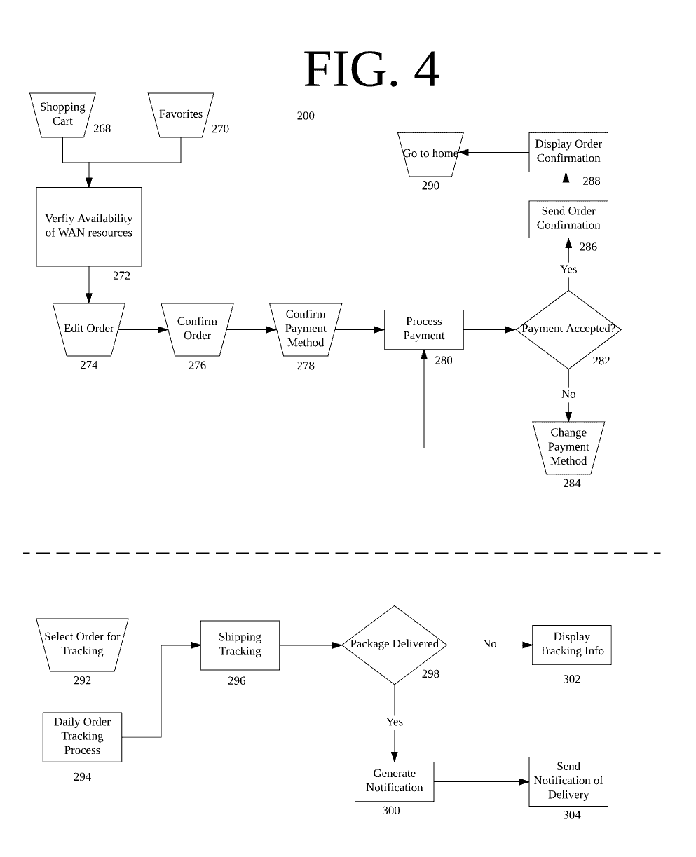

FIG. 4 shows in greater detail the means by which products of the process 200 may be ordered. The shopping cart 268 and favorites 270 of a user may be reviewed manually or automatically for products. The method 200 verifies the availability 272 of WAN resources having the products without further restriction, or with restrictions based on user parameters elsewhere acquired in the process (e.g., price thresholding). The order may be edited 274 and/or confirmed 276. Then payment is tendered/confirmed 178, which is then processed 280. If not accepted 282, payment may be retendered 280, or if accepted 282, an order confirmation may be sent 286 to the user and displayed on its computing 288 device. The method 200 may then be initiated 290 for another product.

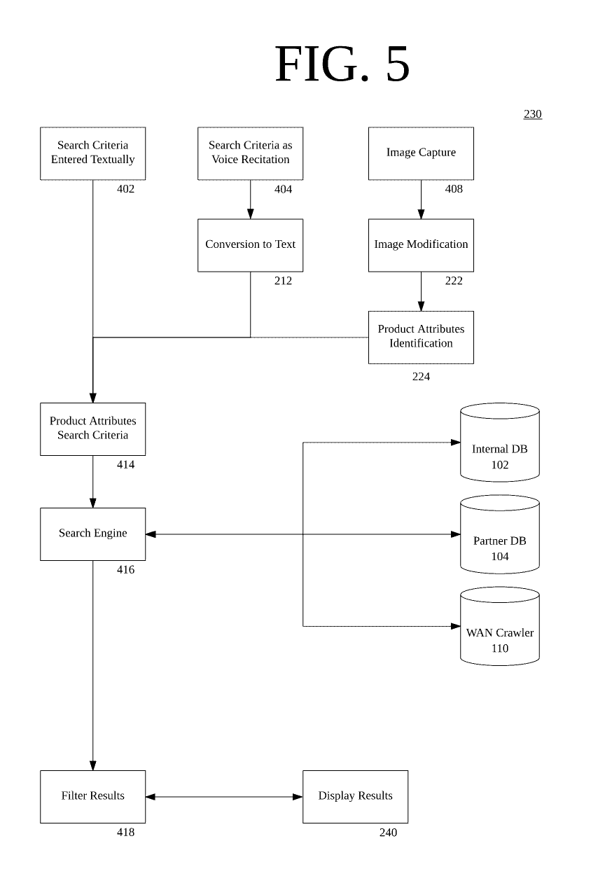

FIG. 5 depicts in greater detail the search 230 step of the present invention. Alphanumeric search attributes may be entered 402 directly. The alphanumeric search attributes may serve as the sole element of the search or used in combination with other search elements. Voice recitation may input 404, which may then be converted 212 to text product attributes. For example, descriptors such as “red” and “HONDA” and “CIVIC” and fast and small may be directly translated, or information may be logically sought in multiple steps. For example, the voice recitation “Jacket from Michael Jackson's BAD video” may result in “Jacket” and “Michael Jackson,” but “BAD” may result in a separate search of user comments for WAN displays of the BAD video.

Images may be captured 408 as photographs or file captures. The images may undergo modification 222 to isolate significant image characteristics, or for other reasons. Product attributers are then harvested 224 from the image, which may be alphanumerics within the image or verbal translations of image elements, e.g. a photograph of a HONDA CIVIC may result in “Automobile” and “Red” and “Sedan” and “Four-door.”

Product attributes from direct entry 402, voice recitation conversion 212, and image attribute harvesting 224 are utilized as product attributes search criteria 414. These search criteria are fed to a search engine that may utilize any informational databases available to it, including internal databases 102, partner databases 104, and databases (ephemeral or indefinite) acquired from information resulting from WAN crawling. Search results are filtered 416 as necessary, including subject to user parameters and are then displayed 240 to a user.

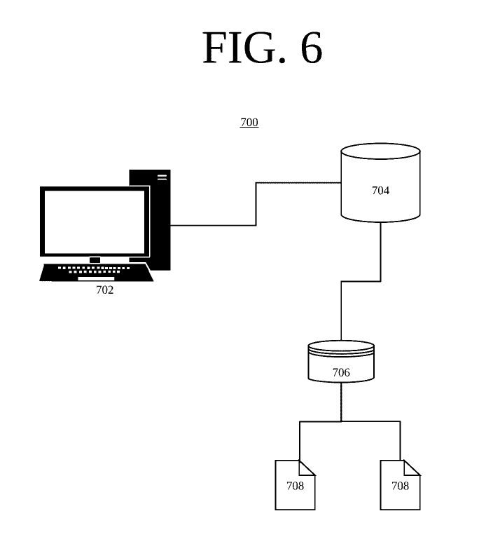

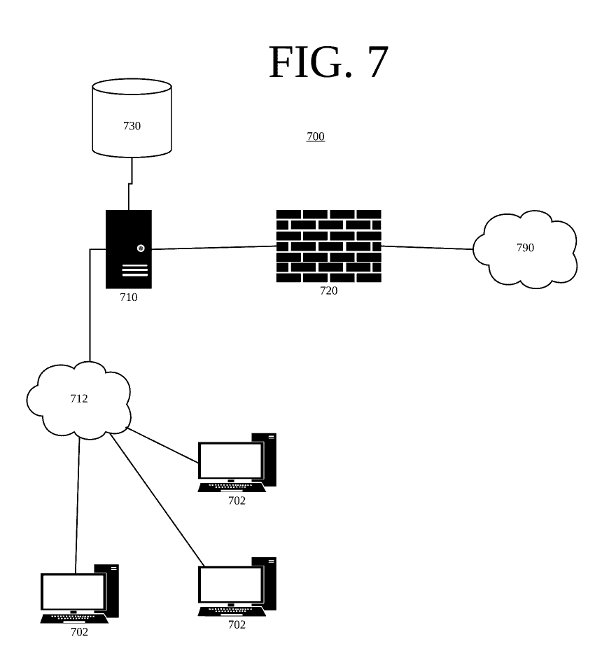

Execution FIGS. 6 and 7 depict a computer ecosystem 700 of the present invention. By ecosystem it is meant one or more computers 702 that are organizationally related. The ecosystem may include computers under common ownership, computers that belong to the same network or series of networks, computers that are collaborating, etc. The present invention may be provided as a computer program product, or software that may include a computer-readable storage medium 704 having stored thereon instructions, which may be used to perform the process of the present invention across a computer ecosystem 700 according to the various embodiments disclosed herein.

A computer 702 of the present invention may include any combination of one or more computer readable media 704. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium 704 may be any tangible medium that can contain, or store a program for use by or in connection with an instruction execution system, apparatus, or device.

A computer readable signal medium 704 may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures described below illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Furthermore, the functionality of one block may be subsumed by the functionality of another block as a substep thereof. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

An ecosystem 700 may further include a computer network or data network that allows computers to exchange data. In a computer network of the present invention, networked computing devices pass data to each other along data connections. The connections between nodes are established using cable media, wireless media, or other media. The Internet or other exterior network 790 may be a component of the ecosystem 700. Nodes may include hosts such as personal computers, phones, servers, and networking hardware. Two such devices are networked together when one device is able to exchange information with the other device, whether or not they have a direct connection to each other. Computer networks of the present invention support applications such as access to the World Wide Web, shared use of application and storage servers, printers, and fax machines, and use of email and instant messaging applications. Computer networks may be included irrespective of the physical media used to transmit their signals, the communications protocols to organize network traffic, the network's size, topology, and organizational intent.

It is preferred that the network of the present invention have at least one boundary 720, and potentially multiple boundaries if a demilitarized zone is utilized. The boundary 720 may include any number of layers designed to regulate and secure the flow of information between networks. Boundary layers of the present invention may include enterprise content management software, firewalls, filters, threat management software, alarms, etc. Software for establishing a boundary may be run on a server 710 with server storage 730 of the present invention, which may include directory services controlling access credentials.

To combat security risks posed by network connections, firewalls are frequently used. A firewall may be a hardware or software component that filters network traffic so that communications with unauthorized third parties are blocked but legitimate network functions may be carried out. Frequently, the filters applied by a firewall are specified by a set of policies defining characteristics of network messages that either should pass through the firewall or that should be blocked. Because different levels of communication may be appropriate depending on the origin or destination of messages, firewall policies may be provided for each application that executes on a computing device and communicates over a network.

A firewall may have an outward side facing a global network, such as the Internet. The opposite side of the firewall may be a private network that is protected by the firewall. The private network may include any number of host machines (e.g., computers) each addressable by its own IP address. The physical construction of the network may be such that all data packets intended for one of the IP addresses behind the firewall pass through the firewall. Using the firewall rules, which may be set by a network administrator or other user, the firewall may determine whether to allow or deny certain data packets and/or determine where to route particular data packets based on the IP addresses to which the packets are directed. The determination of where to route data packets may be done using the IP addresses of the host machines in the private network.

Depending on the addressing scheme used by the network, the IP addresses of the host machines may be static or dynamic. Static IP addresses do not change over time, and thus once they are set in the firewall rules, there is no need to update them. The Internet Protocol version Four (IPv4) addressing system commonly uses static addressing, while IPv6 may use dynamic addressing. Dynamic IP addresses may change over time and thus, there is a need to update the firewall rules as changes occur. When a small Local Area Network (LAN), such as a domestic network in a private residence, is linked to a larger network such as the Internet, the link is often through a gateway router acting as a firewall. One of the functions of the firewall is to protect the LAN from intrusion from outside.

A service directory accessible by a server 710, usually on server storage 730, stores information about network resources across a domain. An example of a directory service is Active Directory. The main purpose of Active Directory is to provide central authentication and authorization services for Windows-based computers. Active Directory also allows administrators to assign policies, deploy software, and apply critical updates to an organization. Active Directory stores information and settings in a central database.

An Active Directory structure is a hierarchical framework of objects. The objects fall into three broad categories: resources (e.g. printers), services (e.g. e-mail) and users (e.g., user accounts and groups). The Active Directory provides information on the objects, organizes the objects, controls access and sets security. Certain objects can also be containers of other objects. An object is uniquely identified by its name and has a set of attributes—the characteristics and information that the object can contain—defined by a schema, which also determines the kind of objects that can be stored in the Active Directory.

Typically, the highest object in the hierarchy is the domain. The domain can be further sub-divided into containers called Organizational Units. Organizational units give a semblance of structure to the organization either based on administrative structure or geographical structure. The organizational unit is the common level at which to apply group policies, which are Active Directory objects themselves called Group Policy Objects. Policies can also be applied to individual objects or attributes as well as at the site level (i.e., one or more IP subnets).

The present invention may use one of more communication networks to foster information exchange throughout the computers of the ecosystem. Communication networks might either be private or public. In a private network, communications between multiple computers occur in a secure environment that prevents access from outside the network without appropriate authentication. These networks are considered as “trusted” networks because the communication signals securely travel from one computer to another within the private network without being exposed to the external environment.

Public networks such as the Internet, on the other hand, are not secure because the communication over these networks is not private and is susceptible to interception by other computers. In addition, the public networks cannot guarantee the delivery of the data packets being sent. They allow packets to be injected into, or ejected out of, the networks indiscriminately, and analyzed while in transit. To keep data sent over a public network private, a Virtual Private Network (VPN) is commonly established on top of a public network when two computers use the public network to communicate with each other. In a Virtual Private Network, data sent from one computer to another is encrypted by a security gateway and transmitted in encrypted form over the public network to a second security gateway connected to the receiving computer. The second gateway decrypts the data before forwarding it to the receiving computer. Such a private channel established on top of another network is referred to as a network tunnel.

In order to set up a Virtual Private Network, a user first establishes a path to a VPN server and goes through an AAA process (Authentication, Authorization and Accounting) for identification and authorization to create a secure tunnel with the server. Once the user is authorized, a secure network tunnel is established between the user and the VPN server over the public network, using a VPN protocol such as IPsec. This process requires a VPN client on the user's side, a VPN server and other VPN hardware on the other side of the tunnel, as well as appropriate user configurations.

Today's private networks often include wireless networks such as WiMAX to accommodate mobile access. In addition, to provide mobility access in a large geographic area, a private enterprise often relies on third-party wireless infrastructures besides its own wireless network. In this case, a user's device would need to be authenticated by both a third-party gateway and an enterprise authentication server before it could access the enterprise network. User credentials are typically requested by and securely returned to the third-party gateway. Once the user is authenticated and authorized, the user may communicate with the third-party wireless gateway.

The present invention includes files 708, which may include executable instructions by which the present invention runs, or files upon and with which the present invention interacts. The documents may be on local storage 704 or shared storage 730 and be created, accessed, edited, and/or otherwise modified using any of a number of applications, including for example and without limitation Final Cut Pro, Avid, Microsoft Office applications (Word, Excel, Power Point, Outlook, Visio, etc.), Adobe Reader or Acrobat, AutoCAD, SolidWorks, or any other suitable document editing application. The content of the documents may be audio tracks, video clips, images, word processing documents, presentations, spreadsheets, business documents, engineering documents, databases, etc.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A method for performing a product search, said method comprising:
receiving as input on a portable electronic device, with a device arithmetic logic unit (“ALU”) and a device nontransitory computer-readable storage medium, a search request for a desired product, wherein said search request comprises an image characterizing said desired product;
converting said image into textual product attributes identifying said desired product using an image-conversion algorithm;
sending said search request loaded with said product attributes to a commercial product inventory database;
setting user-based parameters related to said desired product;
iteratively executing a product search over a Wide Area Network (“WAN”) that compares said product attributes and said parameters against target products found within said commercial product inventory database, stored on an inventory nontransitory computer-readable storage medium, catalogued with target product attributes until said parameters have been met and storing said target products satisfying said parameters as verified target products; and
displaying at least one of said verified target products to said user.

2. The method of claim 1 further comprising the step of processing a sales transaction for at least one of said verified target products.

3. The method of claim 1 wherein said receiving step include receiving as input an image characterizing said desired product from a photograph.

4. The method of claim 3 wherein said receiving step include receiving as input an image characterizing said desired product from a WAN resource.

5. The method of claim 1 wherein said converting step further includes the step of converting said image into textual product attributes further based on a second user textual product attributes from a second user image construed to be substantially equivalent to said image.

6. The method of claim 1 wherein said displaying step further comprises the step of displaying at least one of said verified target products to a WAN resource.

7. The method of claim 1 wherein said setting step further includes updating said user-based parameters subsequent to said displaying step, and said iteratively executing step includes iteratively executing said product search with said parameters as updated.

8. The method of claim 1 wherein said displaying step includes retailer information related to said verified target product.

9. The method of claim 8 wherein said displaying step includes retailer information related both to said verified target product and a geo-characteristic of said user.

10. A method for performing a product search, said method comprising:
receiving as input on a portable electronic device, with a device arithmetic logic unit (“ALU”) and a device nontransitory computer-readable storage medium, a search request for a desired product, wherein said search request comprises a voice recitation characterizing said desired product;
converting said voice recitation into textual product attributes identifying said desired product using a voice modulation algorithm;
sending said search request loaded with said product attributes to a commercial product inventory database;
setting user-based parameters related to said desired product;
iteratively executing a product search over a Wide Area Network (“WAN”) that compares said product attributes and said parameters against target products found within said commercial product inventory database, stored on an inventory nontransitory computer-readable storage medium, catalogued with target product attributes until said parameters have been met and storing said target products satisfying said parameters as verified target products; and
displaying at least one of said verified target products to said user.

11. The method of claim 10 further comprising the step of processing a sales transaction for at least one of said verified target products.

12. The method of claim 10 wherein said receiving step include receiving as input a voice recitation characterizing said desired product from a device microphone.

13. The method of claim 12 wherein said receiving step include receiving as input a voice recitation characterizing said desired product from a WAN resource.

14. The method of claim 10 wherein said converting step further includes the step of converting said voice recitation into textual product attributes further based on a second user textual product attributes from a second user voice recitation construed to be substantially equivalent to said voice recitation.

15. The method of claim 10 wherein said displaying step further comprises the step of displaying at least one of said verified target products to a WAN resource.

16. The method of claim 1 wherein said setting step further includes updating said user-based parameters subsequent to said displaying step, and said iteratively executing step includes iteratively executing said product search with said parameters as updated.

17. The method of claim 10 wherein said displaying step includes retailer information related to said verified target product.

18. The method of claim 17 wherein said displaying step includes retailer information related both to said verified target product and a geo-characteristic of said user.

19. A system for the aggregation of product attributes, said system comprising:
a backend database stored on a computer, with a computer arithmetic logic unit (“ALU”) and a computer nontransitory computer-readable storage medium, for the aggregation from multiple WAN resources of target products along with native target product attributes;
a user channel, for the bidirectional communication of information between said database and a user over a WAN, permitting both (i) user upload of indirect product attributes comprising non-textual components, and (ii) user download of verified target products allegedly corresponding to said indirect product attributes;
a converter for converting said indirect product attributes into textual desired product attributes;
a comparator for searching and comparing target product attributes to said textual desired product attributes to find as verified target product attributes meeting said desired product attributes; and
a database updater for the modification of target product attributes to include elements of said textual desired product attributes to at least one of said target product attributes for at least one of said target products.

20. The system of claim 19 further comprising a user client adapted to store product attributes of verified target product attributes and correlate the same to a user as prior attributes; and wherein said comparator utilizes prior attributes in searching and comparing target product attributes.
